(19) United States
(12) Patent Application Publication
(10) Pub. No.: US 2006/0256860 A1
(43) Pub. Date: Nov. 16, 2006

(54) Transcoding with look-ahead

(76) Inventor: Stephen Elliott Gordon, North Andover, MA (US)

Correspondence Address: MCANDREWS HELD & MALLOY, LTD, 500 WEST MADISON STREET, SUITE 3400, CHICAGO, IL, 60661, US

(21) Appl. No.: 11/434,491

(22) Filed: May 15, 2006

Related U.S. Application Data
(60) Provisional application No. 60/681,636, filed on May 16, 2005.

(51) Int. Cl. H04N 11/04; H04B 1/66; H04N 11/02; H04N 7/12

(52) U.S. Cl. 375/240.03

(57) ABSTRACT

Described herein is a video encoder that includes a memory unit, a selector, and an encoding processor. The memory unit stores a plurality of pictures. The selector accesses the plurality of pictures in the memory unit. The selector initially accesses a first picture, followed by another picture, followed by one or more pictures. The one or more pictures are presented to the video encoder between the first picture and the another picture. The encoding processor encodes the first picture independently, then encodes the another picture independently, and finally, the one or more pictures are encoded. The output of the encoding processor is a first coded picture, another coded picture, and one or more coded pictures respectively.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Digital video encoders may use variable bit rate (VBR) encoding. VBR encoding can be performed in real-time or off-line. Real-time VBR encoding will typically have an associated Quality of Service (QoS) that specifies transmission delay, absolute time variation, and information loss. Also, the transmission of real-time video streams is resource-intensive as it requires a large bandwidth. Efficient utilization of bandwidth will increase channel capacity, and therefore, revenues of video service providers will also increase.

VBR encoded video is bursty in nature, and uncontrolled burstiness will lead to inefficient use of bandwidth. To guarantee a QoS level, rate control is utilized. VBR encoding can achieve improved coding efficiency by better matching the encoding rate to the video complexity and available bandwidth if the burstiness of the video can be controlled. Therefore, a need exists for a system and method to realize bandwidth savings in variable bit-rate video encoders. Bandwidth savings can increase the channel multiplexing capability while maintaining the video quality desired by the application, or increase the video quality while maintaining the channel throughput.

Video transcoding is the process of converting a video sequence in one compressed form to another compressed form. Transcoding can be used in a number of ways. In one way, the bit rate of the compressed video stream can be changed. This is called transrating. In another way, a stream can be converted from one standard to another standard to improve compression efficiency. In another way, the resolution of the underlying video sequence can be changed. This is called transcaling.

A straightforward way of transcoding is to fully decode a sequence, do any intermediate processing, and then fully encode the video sequence to generate another video sequence. Many approaches have been developed to simplify the processing by doing less than a full decode and encode. One example of this is when transrating, one might just decode, dequantize, requantize, and record the transform coefficients while leaving the rest of the compressed video sequence alone. However, the foregoing approaches sacrifice quality relative to the straightforward transcoder.

Other approaches have been developed to improve the quality of the transcoding process. Typically, these have relied on applying well-known advanced encoder techniques. An example of such a technique is to “look ahead” at future frames to assist in the bit allocation process for the current frame. By looking ahead, an encoder can determine the complexity of the current frame relative to the frames in the future, and which sections of the current frame persist in to the future. The problem with this technique is that it requires buffering the future raw video frames, thereby requiring a large amount of storage. Furthermore, in some systems where the encoding time is critical, the data rates associated with moving the future frames in and out of storage requires the use of relatively expensive forms of storage.

Additional limitations and disadvantages of conventional and traditional approaches will become apparent to one of ordinary skill in the art through comparison of such systems with the present invention as set forth in the remainder of the present application with reference to the drawings.

### BRIEF SUMMARY OF THE INVENTION

Described herein are video encoder(s) and method(s) for improving the video quality of coded video data.

In one embodiment, there is presented a method for encoding pictures. The method comprises looking ahead in a series of pictures that are compressed in accordance with a compression standard; selecting a particular one of the compressed pictures; decompressing the particular one of the compressed pictures; generating a metric, where the metric measures the complexity of the particular one of the compressed pictures; and allocating a number of bits for a current picture from the series of compressed pictures, based on the metric.

In another embodiment, there is presented a system for encoding pictures. The system comprises a decoder and an encoder. The decoder looks ahead in a series of pictures that are compressed in accordance with a compression standard; selects a particular one of the compressed pictures; and decompresses the particular one of the compressed pictures. The encoder generates a metric, where the metric measures the complexity of the particular one of the compressed pictures; and allocates a number of bits for a current picture from the series of compressed pictures, based on the metric.

In another embodiment, there is presented a circuit for encoding pictures. The circuit comprises a processor and a memory connected to the processor. The memory stores a plurality of instructions that are executable by the processor. Execution of the instructions causes looking ahead in a series of pictures that are compressed in accordance with a compression standard; selecting a particular one of the compressed pictures; decompressing the particular one of the compressed pictures; generating a metric, where the metric measures the complexity of the particular one of the compressed pictures; and allocating a number of bits for a current picture from the series of compressed pictures, based on the metric.

These and other advantages and novel features of the present invention, as well as illustrated embodiments thereof will be more fully understood from the following description and drawings.

### BRIEF DESCRIPTION OF THE DRAWINGS

FIG. 1 is a block diagram of exemplary video data encoded in accordance with an embodiment of the present invention;

FIG. 2 is a flow diagram for encoding video data in accordance with an embodiment of the present invention;

FIG. 3 is a block diagram of an exemplary circuit in accordance with an embodiment of the present invention;

FIG. 4A is a block diagram describing the MPEG-2 encoding process;

FIG. 4B is a block diagram of exemplary frames with interdependencies;

FIG. 5 is a block diagram of an exemplary encoder in accordance with an embodiment of the present invention.

### DETAILED DESCRIPTION OF THE INVENTION

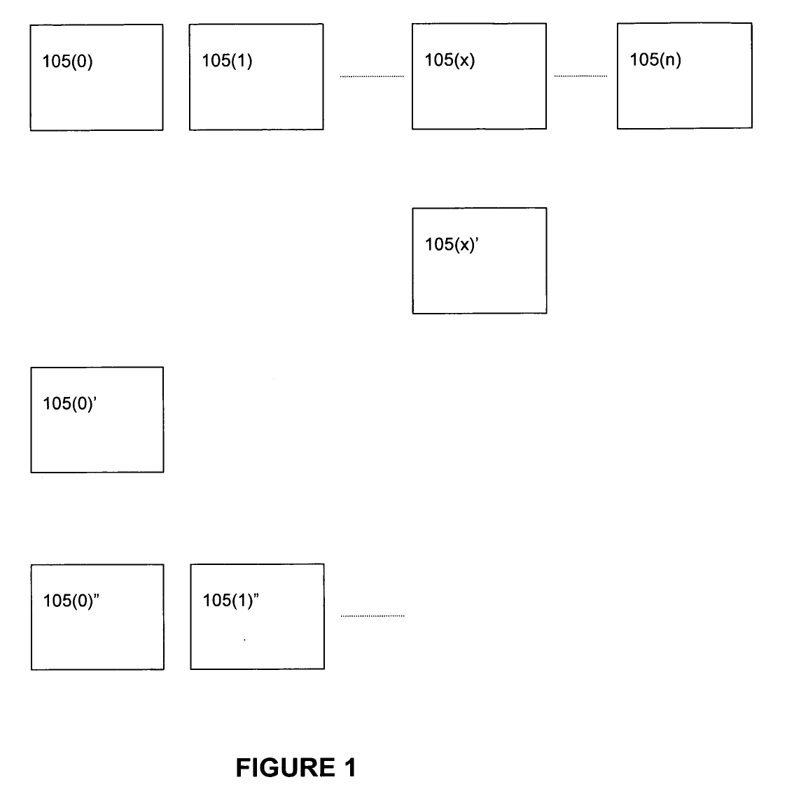

Referring now to FIG. 1, there is illustrated a block diagram describing exemplary video data encoded in accordance with an embodiment of the present invention. The video data 100 comprises a series of pictures 105(0) . . . 105(n) that are encoded in accordance with a compression standard.

The series of pictures 105 are transcoded to another compression standard 105″. To transcode a current picture, e.g., picture 105(0), a look ahead is performed in series of pictures to select a particular one of the pictures, picture 105(x). Picture 105(x) is decompressed 105(x)′. The complexity of picture 105(x)′ can be measured to generate a metric.

According to certain aspects of the present invention, the selected picture 105(x) can be an intracoded picture. For example, in MPEG-2 and H.264, the series of pictures comprises any number of groups of pictures (GOP) The selected picture 105(x) can be the first picture in the next GOP from current picture 105(0).

The metric can be used for encoding the current picture 105(0), and the pictures 105(1) . . . 105(x−1) between the current picture 105 (0) and the selected picture 105(x). In order to transcode and transmit video data 105″ in real time, it is advantageous to appropriately allocate bandwidth among the transcoded pictures 105″. This can be done by controlling the number of bits that are used that make up the transcoded picture 105(0)″. For example, where the selected picture 105(x)′ is complex, relative to the current picture 105(0)′, fewer bits can be allocated for transcoding the current picture 105(0)″. In certain embodiments of the invention, an examination can be made of which sections of the current picture 105(0)′ exist in the selected picture 105(x)′. Additionally, the decompressed picture 105(x)′ can be stored in a buffer. When the decompressed picture 105(x)′ becomes the current picture, the picture 105(x) does not have to be decompressed. Additionally, a look-ahead can be performed to select another later picture, e.g., 105(n).

The number of bits that are used to make up the transcoded picture 105(0) can be controlled by varying certain parameters in the other compression standard. For example, where the other compression standard is H.264, the quantization levels can be varied. Accordingly, the current picture 105(0) is decompressed and encoded according to the other compression standard.

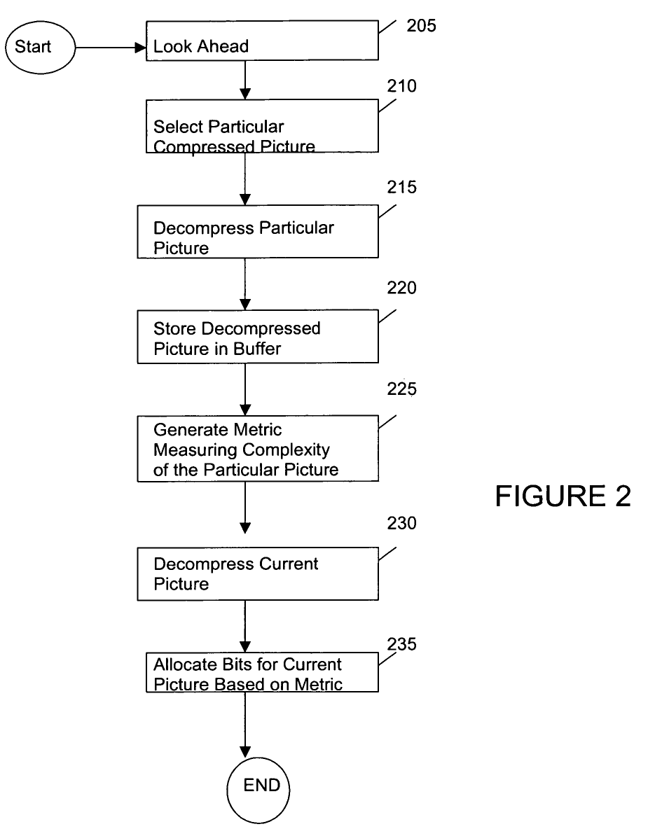

Referring now to FIG. 2, there is illustrated a flow diagram for transcoding a series of pictures. At 205, a look-ahead is performed in a series of pictures that are compressed in accordance with a compression standard to select (at 210) a particular one of the compressed pictures, e.g, picture 105(x).

According to certain aspects of the present invention, the selected picture 105(x) can be an intracoded picture. For example, in MPEG-2 and H.264, the series of pictures comprises any number of groups of pictures (GOP) . The selected picture 105(x) can be the first picture in the next GOP from current picture 105(0).

At 215, the particular one of the compressed pictures 105(x) is decompressed, thereby resulting in decompressed picture 105(x)′. At 220, the decompressed picture 105(x)′ is stored in a buffer. At 225, a metric measuring the complexity of the particular picture 105(x) is generated.

At 230, the current picture 105(0) is decompressed and the decompressed picture 105(0)′. At 235, the number of bits for the current picture 105(0) are allocated based on the metric calculated during 225. At 240, the decompressed picture 105(0)′ is compressed in accordance with the other encoding standard, resulting in transcoded picture 105(0)″.

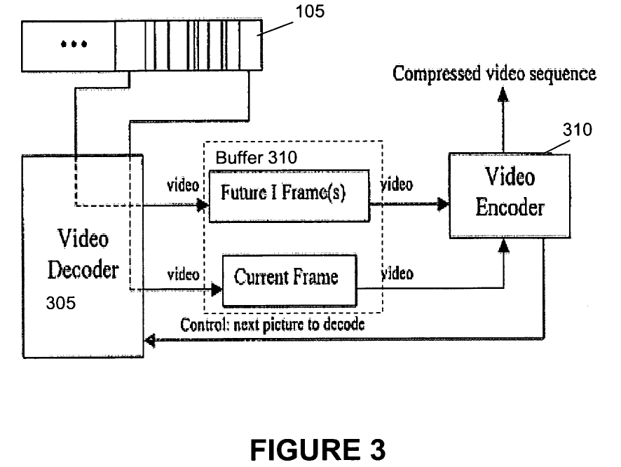

Referring now to FIG. 3, there is illustrated a block diagram describing a circuit in accordance with an embodiment of the present invention. The circuit comprises a video decoder 305, a video encoder 310, and a buffer 315.

The video encoder 310 instructs the video decoder 305 to look-ahead in the series of compressed pictures and select a particular one of the compressed pictures, e.g, picture 105(x). According to certain aspects of the present invention, the selected picture 105(x) can be an intracoded picture. For example, in MPEG-2 and H.264, the series of pictures comprises any number of groups of pictures (GOP). The selected picture 105(x) can be the first picture in the next GOP from current picture 105(0).

The decoder 305 decompresses the particular pictures 105(x), resulting in decompressed picture 105(x). The buffer 315 stores the decompressed picture 105(x)′. The encoder 310 generates a metric measuring the complexity of the particular picture 105(x).

The decoder 305 decompresses the current picture 105(0), resulting in decompressed picture 105(0)′. The encoder 310 allocates a number of bits for the current picture based on the calculated metric and compresses picture 105(0)′ in accordance with the other encoding standard, resulting in transcoded picture 105(0)″.

An exemplary compression standard, MPEG-2, will now be described, followed by an embodiment of the present invention, wherein MPEG-2 encoded video is transcoded to H.264. Although the MPEG-2 and H.264 standards are described, the present invention is not limited to the MPEG-2 and H.264 standards and can be used with other standards as well.

MPEG-2

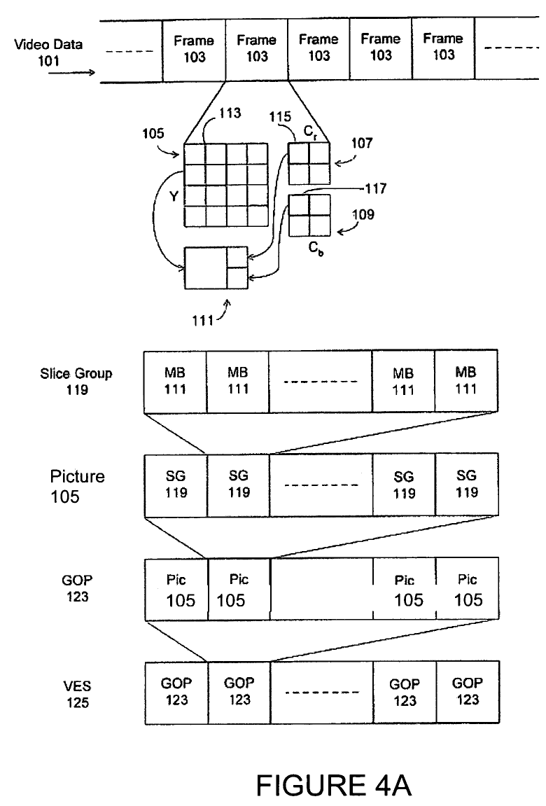

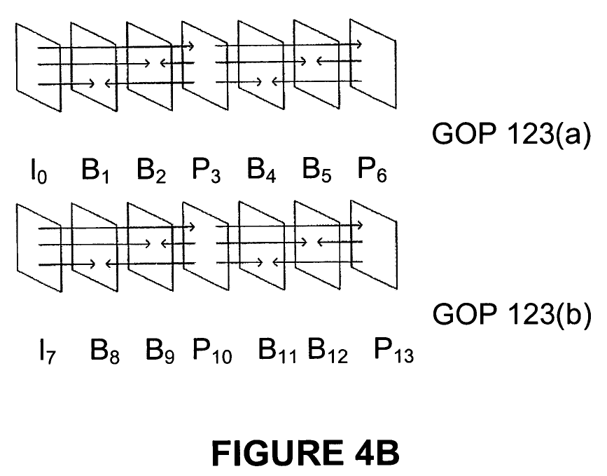

FIG. 4A illustrates a block diagram of an exemplary Moving Picture Experts Group (MPEG) encoding process of video data 101, in accordance with an embodiment of the present invention. The video data 401 comprises a series of frames 105. Each frame 105 comprises two-dimensional grids of luminance Y, chrominance red Cᵣ and chrominance blue C_{b}, pixels.

The two-dimensional grids are divided into 8×8 blocks, where a group of four blocks or a 16×16 block 113 of luminance pixels Y is associated with a block 115 of chrominance red Cᵣ, and a block 117 of chrominance blue C_{b} pixels. The block 113 of luminance pixels Y, along with its corresponding block 115 of chrominance red pixels Cᵣ, and block 117 of chrominance blue pixels C_{b} form a data structure known as a macroblock 111. The macroblock 111 also includes additional parameters, including motion vectors, explained hereinafter. Each macroblock 111 represents image data in a 16×16 block area of the image.

The data in the macroblocks 111 is compressed in accordance with algorithms that take advantage of temporal and spatial redundancies. For example, in a motion picture, neighboring frames 105 usually have many similarities. Motion causes an increase in the differences between frames, the difference being between corresponding pixels of the frames, which necessitate utilizing large values for the transformation from one frame to another. The differences between the frames may be reduced using motion compensation, such that the transformation from frame to frame is minimized. The idea of motion compensation is based on the fact that when an object moves across a screen, the object may appear in different positions in different frames, but the object itself does not change substantially in appearance, in the sense that the pixels comprising the object have very close values, if not the same, regardless of their position within the frame. Measuring and recording the motion as a vector can reduce the picture differences. The vector can be used during decoding to shift a macroblock 111 of one frame to the appropriate part of another frame, thus creating movement of the object. Hence, instead of encoding the new value for each pixel, a block of pixels can be grouped, and the motion vector, which determines the position of that block of pixels in another frame, is encoded.

Accordingly, most of the macroblocks 111 are compared to portions of other frames 105 (reference frames). When an appropriate (most similar, i.e. containing the same object(s)) portion of a reference frame 103 is found, the differences between the portion of the reference frame 103 and the macroblock 111, known as the residual, are encoded. The location of the portion in the reference frame 103 is recorded as a motion vector. The residual and the motion vector form part of the data structure encoding the macroblock 111.

In the MPEG-2 standard, the macroblocks 111 from one frame 103 (a predicted frame) are limited to prediction from portions of no more than two reference frames 105. It is noted that frames 105 used as a reference frame for a predicted frame 103 can be a predicted frame 103 from another reference frame 103.

The macroblocks 111 representing a frame are grouped into different slice groups 119. The slice group 119 includes the macroblocks 111, as well as additional parameters describing the slice group. Each of the slice groups 119 forming the frame form the data portion of a picture structure 121. The picture 105 includes the slice groups 119 as well as additional parameters that further define the picture 105.

I₀, B₁, B₂, P₃, B₄, B₅, P₆, I₇, B₈, B₉, P₁₀, B₁₁, B₁₂, and P₁₃, FIG. 4B, are exemplary pictures representing frames. The arrows illustrate the temporal prediction dependence of each picture. For example, picture B₂ is dependent on reference pictures I₀, and P₃. Pictures coded using temporal redundancy with respect to exclusively earlier pictures of the video sequence are known as predicted pictures (or P-pictures), for example picture P₃ is coded using reference picture I₀. Pictures coded using temporal redundancy with respect to earlier and/or later pictures of the video sequence are known as bi-directional pictures (or B-pictures), for example, pictures B₁ is coded using pictures I₀ and P₃. Pictures not coded using temporal redundancy are known as I-pictures, for example I₀. In the MPEG-2 standard, I-pictures and P-pictures are also referred to as reference pictures.

The pictures are then grouped together as a group of pictures (GOP) 123. For example, pictures I₀, B₁, B₂, P₃, B₄, B₅, and P₆, can be grouped into one GOP 123(a), while pictures I₇, B₈, B₉, P₁₀, B₁₁, B₁₂, and P₁₃ can be grouped into another GOP 123(b). Referring again to FIG. 4A, the GOP 123 also includes additional parameters further describing the GOP. Groups of pictures 123 are then stored, forming what is known as a video elementary stream (VES) 125. The VES 125 is then packetized to form a packetized elementary sequence. Each packet is then associated with a transport header, forming what are known as transport packets.

Referring again to FIG. 3, according to certain aspects of the present invention, the MPEG-2 video data can be transcoded to H.264 encoded data. The video encoder 310 can instruct a video decoder 305 to look-ahead in the series of compressed pictures and select the first picture, I₇ in the next GOP, GOP 423(b), from current picture I₀. The decoder 305 decompresses picture I₇ and encoder 310 generates a metric measuring the complexity of picture I₇.

The decoder 305 decompresses the current picture I₀. The encoder 310 allocates a number of bits for picture I₀ based on the calculated metric and compresses picture I₀ in accordance with H.264. The number of bits that are used to make up the transcoded picture I₀ can be controlled by varying the quantization levels that are used to quantize data for picture I₀. Accordingly, the current picture I₀ is compressed and encoded according to H.264.

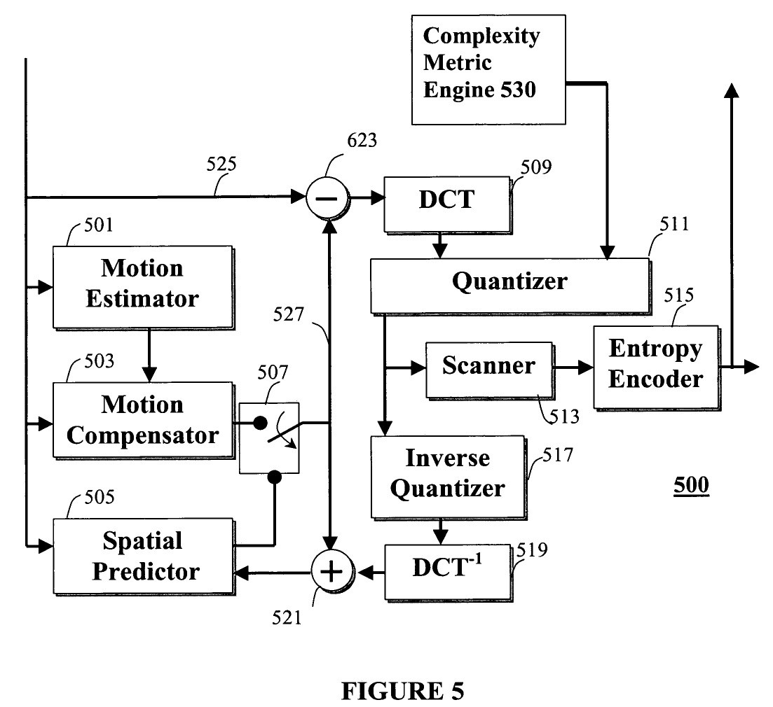

Referring now to FIG. 5, there is illustrated a block diagram describing an exemplary video encoder 500 in accordance with an embodiment of the present invention. The video encoder 500 encodes video data 525 comprising a set of frames. The video encoder 500 comprises a motion estimator 501, a motion compensator 503, a spatial predictor 505, a discrete cosine transformation engine (DCT) 509, a quantizer 511, a scanner 513, an entropy encoder 515, an inverse quantizer 517, and an inverse discrete cosine transformation engine (DCT⁻¹) 519. The foregoing can comprise hardware accelerator units under the control of a CPU.

When video data 525 is presented for encoding, the video encoder 500 processes in units of macroblocks. The video encoder 500 can encode each macroblock using either spatial or temporal prediction. In each case, the video encoder forms a prediction block 527 that can be selected by a switch 507. In spatial prediction mode, the spatial predictor 505 forms the prediction block 527 from samples of the current frame 525 and one that was previously encoded. In temporal prediction mode, the motion estimator 501 and motion compensator 503 form a prediction macroblock 527 from one or more reference frames. Additionally, the motion estimator 501 and motion compensators 503 provide motion vectors identifying the prediction block. The motion vectors can also be predicted from motion vectors of neighboring macroblocks.

A subtractor 523 subtracts the prediction macroblock 527 from the macroblock in the current frame 525, resulting in a prediction error. The transformation engine 509 and quantizer 511 transform and quantize the prediction error, resulting in a set of quantized transform coefficients. The scanner 513 reorders the quantized transform coefficients. The entropy encoder 515 encodes the coefficients.

The encoder can also include a complexity metric engine 530 that measures the complexity of the look ahead picture. A series of quantization levels may be precomputed and stored in memory. The storage and selection of the quantization levels may occur in the complexity metric engine 530 or the quantizer 511 based on the calculations of the metric engine 530.

The video encoder also decodes the quantized transform coefficients, via the inverse quantizer 517 and the inverse transformation engine 519. The decoded transform coefficients are added 521 to the prediction macroblock 527 and used by the spatial predictor 505.

The embodiments described herein may be implemented as a board level product, as a single chip, application specific integrated circuit (ASIC), or with varying levels of a video encoder circuit integrated with other portions of the system as separate components.

The degree of integration of the video encoder circuit may primarily be determined by speed and cost considerations. Because of the sophisticated nature of modern processors, it is possible to utilize a commercially available processor, which may be implemented external to an ASIC implementation.

If the processor is available as an ASIC core or logic block, then the commercially available processor can be implemented as part of an ASIC device wherein certain functions can be implemented in firmware as instructions stored in a memory. Alternatively, the functions can be implemented as hardware accelerator units controlled by the processor.

While the present invention has been described with reference to certain embodiments, it will be understood by those skilled in the art that various changes may be made and equivalents may be substituted without departing from the scope of the present invention.

Additionally, many modifications may be made to adapt a particular situation or material to the teachings of the present invention without departing from its scope. For example, although the invention has been described with a particular emphasis on MPEG-2 and H.264 video data, the invention can be applied to a video data encoded with a wide variety of standards.

Therefore, it is intended that the present invention not be limited to the particular embodiment disclosed, but that the present invention will include all embodiments falling within the scope of the appended claims.

1. A method for encoding pictures, said method comprising:
looking ahead in a series of pictures that are compressed in accordance with a compression standard;
selecting a particular one of the compressed pictures;
decompressing the particular one of the compressed pictures;
generating a metric, said metric measuring the complexity of the particular one of the compressed pictures; and
allocating a number of bits for a current picture from the series of compressed pictures, based on the metric.

2. The method of claim 1, further comprising:
decompressing the current picture; and
compressing the current picture in accordance with another compression standard.

3. The method of claim 1, further comprising:
storing the decompressed particular one of the compressed pictures.

4. The method of claim 1, wherein the particular one of the compressed pictures is an intra-coded picture.

5. The method of claim 1, wherein the compression standard comprises MPEG-2.

6. The method of claim 1, wherein the another compression standard comprises H.264.

7. The method of claim 1, wherein allocating the bits further comprises varying a quantization level for the current picture.

8. A system for encoding pictures, said system comprising:
a decoder for:
looking ahead in a series of pictures that are compressed in accordance with a compression standard;
selecting a particular one of the compressed pictures; and
decompressing the particular one of the compressed pictures; and
an encoder for:
generating a metric, said metric measuring the complexity of the particular one of the compressed pictures; and
allocating a number of bits for a current picture from the series of compressed pictures, based on the metric.

9. The system of claim 8, further comprising:
wherein the decoder decompresses the current picture; and
wherein the encoder compresses the current picture in accordance with another compression standard.

10. The system of claim 8, further comprising:
a buffer for storing the decompressed particular one of the compressed pictures.

11. The system of claim 8, wherein the particular one of the compressed pictures is an intra-coded picture.

12. The system of claim 8, wherein the compression standard comprises H.261.

13. The system of claim 8, wherein the another compression standard comprises H.263.

14. The system of claim 8, wherein the encoder comprises a quantizer for varying the quantization level for the current picture.

15. A circuit for encoding pictures, said circuit comprising:
a processor; and
memory connected to the processor, said memory storing a plurality of instructions that are executable by the processor, wherein execution of the instructions by the processor causes:
looking ahead in a series of pictures that are compressed in accordance with a compression standard;
selecting a particular one of the compressed pictures;
decompressing the particular one of the compressed pictures;
generating a metric, said metric measuring the complexity of the particular one of the compressed pictures; and
allocating a number of bits for a current picture from the series of compressed pictures, based on the metric.

16. The circuit of claim 15, wherein execution of the plurality of instructions also causes:
decompressing the current picture; and
compressing the current picture in accordance with another compression standard.

17. The circuit of claim 15, wherein execution of the plurality of instructions also causes:
storing the decompressed particular one of the compressed pictures.

18. The circuit of claim 15, wherein the particular one of the compressed pictures is an intra-coded picture.

19. The circuit of claim 15, wherein allocating the bits further comprises varying a quantization level for the current picture.

20. The circuit of claim 15, wherein the compression standard comprises VC-1 and wherein the another compression standard comprises MPEG-4, Part II.
